(19) United States
(12) Patent Application Publication
(10) Pub. No.: US 2012/0138630 A1
(43) Pub. Date: Jun. 7, 2012

(54) Bulk liquid strorage and transport tank, method of converting shipping containers to bulk liquid storage and transport tanks, and method of use thereof

(75) Inventors: E. Wayne Kinsey, III, Houston, TX (US); Gordon Randall Dixon, Midland, TX (US); Dale Lamborn, Midland, TX (US)

(73) Assignee: Benchmark Performance Group, Inc.

(21) Appl. No.: 13/373,804

(22) Filed: Nov. 30, 2011

Related U.S. Application Data
(60) Provisional application No. 61/458,737, filed on Dec. 1, 2010.

(51) Int. Cl. B67D 7/78; B23P 19/04; B67D 7/00; B67D 7/22

(52) U.S. Cl. 222/1; 222/130; 222/23; 29/401.1

(57) ABSTRACT

A shipping container is converted into a storage and transport tank including a liquid reservoir room and a control room having a pump and a control system for the pump. The pump communicates with the liquid reservoir room via a fill line and a suction line. In operation, the control system activates the pump and opens flow control valves of the inlet line and the fill line to deliver liquid into the liquid reservoir room. Conversely, the control system activates the pump and opens flow control valves of the outlet line and the suction line to remove liquid from the liquid reservoir room. The control system further activates the pump and opens the flow control valves of the suction line and the fill line to recirculate liquid within the liquid reservoir room.

### RELATED APPLICATION

This present application claims all available benefit, under 35 U.S.C. §119(e), of U.S. provisional patent application Ser. No. 61/458,737 filed Dec. 1, 2010. By this reference, the full disclosure of U.S. provisional patent application Ser. No. 61/458,737 is incorporated herein as though now set forth in its entirety.

### BACKGROUND OF THE INVENTION

1. Field of the Invention

The field of the invention relates generally to bulk liquid storage and transport tanks and the conversion of shipping containers to moveable liquid storage and transport tanks. More specifically the invention relates to the process to manufacture moveable liquid storage tanks and to tanks suitable for the transport of liquids from common shipping containers. The storage tanks are insulated and can be stackable. In addition, the storage tanks can incorporate a pump control room that allows the control of the flow into and out of the storage tank, the pump control room can also be configured to control the flow into and out of multiple shipping containers.

2. Description of the Related Art

Large, movable tanks of various sizes and configurations are currently available for temporary storage and dispensing of liquids, such as fracturing fluids, drilling muds, and the like, for use at oil or gas well sites. Historically, such tanks have typically been cylindrical and set horizontally, or are rectangular cubes, with each, regardless of shape, having a capacity of about 20,000 gallons (or 500 bbls.) Such tanks can also be used for temporarily storing liquids at industrial plants and for receiving and holding liquids on spills and environmental clean-up jobs until the contents can be properly disposed. Where circumstances require liquids storage considerably in excess of the capacity of a single 20,000 gallon tank, such as might be required for the hydraulic fracturing treatment of an oil or gas well, a series of such tanks are manifolded together to provide for the rapid delivery of liquids since well treatments often require high volumes of liquids to be delivered to the well bore. Such large tanks are suitable only for the storage of liquids, and not suitable because of their size and loaded-out weight for the transport of liquids.

When the empty tanks are no longer needed, they can be transported by truck from one site to another, where they are refilled and reused. As various federal, state, and local highway ordinances limit the size of trailers for over-the-road transport, the tanks usually have dimensions conforming to the highway ordinances. In response to a movement in recent years towards tanks with smaller footprints to accommodate the requirement for more total available volume without a corresponding increase in well-site location space to place them, modern “frac” tanks are invariably box (rather than cylindrical) shaped, and have evolved into costly, special-purpose tractor-trailer tanks, complete with a rear axle and wheels to enable towing of the tanks from one site to another. These special-purpose frac tanks can include jacking and leveling systems, auxiliary equipment and storage, and custom configurations which deviate from a geometrically “regular” box to maintain a transportable design without compromising volume capacity.

Because of their size and complexity, however, current frac tanks can be costly and difficult to manufacture, expensive to transport and lease for an extended periods of time, and, absent pump and control capabilities, difficult to network into external piping and high pressure pumping systems typically found at oil and gas well drilling and completion sites. Further, the current frac tanks are not rated and therefore not suitable for the transport of liquids. That current tanks must be hauled and set empty, then filled to be functional, and then emptied to be moved adds further to the difficulties inherent in their use.

The present invention addresses the need for a more modular and transportable liquid storage or frac tank having a large capacity but which is less expensive to build and operate, is easily transported between locations, which can provide for a smaller tankage footprint at jobsites, is suitable for the liquids, and contains its own pump and control system.

### SUMMARY OF THE INVENTION

In accordance with the present invention, a method is provided herein for the construction of a storage tank for the storage of liquids at a fixed location. A shipping container having a bottom section, a top section, two side sections and two end pieces is obtained. In the preferred embodiments, the shipping container is a Series 1 General Freight Container manufactured to ISO Standard 668. A bulkhead is installed between and parallel to the end pieces to form an anterior control and pump room and a posterior reservoir room. The bottom and sides of the reservoir room are sealed with a series of layers of foam and plastic to form a seamless liquid container. The bottom and sides of the reservoir room should include a sufficient number of alternate layers of foam and plastic to insulate the liquids contained in the posterior reservoir room from extreme temperature fluctuations. The two reservoir sidewalls may include side panels having stiffening ribs associated therewith. The posterior reservoir room is plumbed to facilitate the transfer of liquids to and from it through the anterior pump and control room. The anterior control and pump room may be provided with pumps and controls to affect the transfer of liquids from the posterior reservoir room. The tank may be provided with access ports formed in the top section of the posterior reservoir room that allow for the cleaning, repair, and maintenance of the internal surfaces of the reservoir. The container may be reinforced such that it supports a second or multiple container(s) stacked atop. Once completed, the tank is transportable on a shipping container transport, may be loaded and unloaded from the shipping container transport with a forklift, and may be loaded and unloaded from a tilt-bed shipping container transport.

Features and advantages of the invention will be apparent from the detailed description that follows, which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings.

### BRIEF DESCRIPTION OF DRAWINGS

FIG. 1 is a perspective view in partial cross-section illustrating a liquid storage and transport tank according to the present invention.

FIG. 2 is a top view illustrating a liquid storage and transport tank according o the present invention

FIG. 3 is a side view illustrating a liquid storage and transport tank according to the present invention.

FIG. 4 is a perspective view illustrating a control and pump room for a liquid storage and transport tank according to the present invention.

FIG. 5 is a block diagram illustrating a control and pump room for a liquid storage and transport tank according to the present invention.

FIG. 6 is a block diagram illustrating a control system for a liquid storage and transport tank according to the present invention.

FIG. 7 is a block diagram illustrating the coupling together of multiple liquid storage and transport tanks.

FIG. 8 is a block diagram illustrating an alternative coupling together of multiple liquid storage and transport tanks.

FIG. 9 is a perspective view illustrating an alternative liquid storage and transport tank according to the present invention.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps. The present invention provides a method and system for converting shipping containers into transportable storage tanks for the temporary storage of liquids at a fixed location.

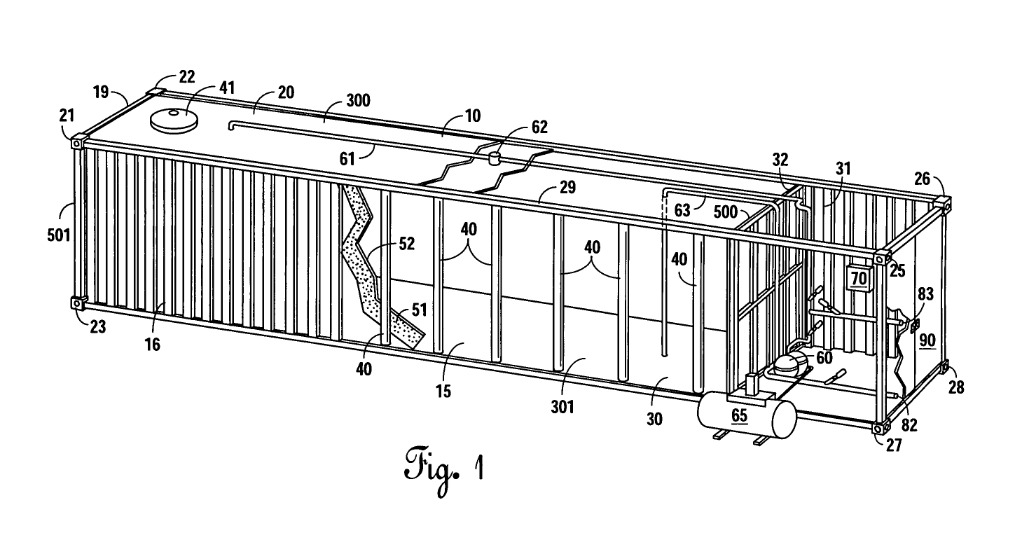

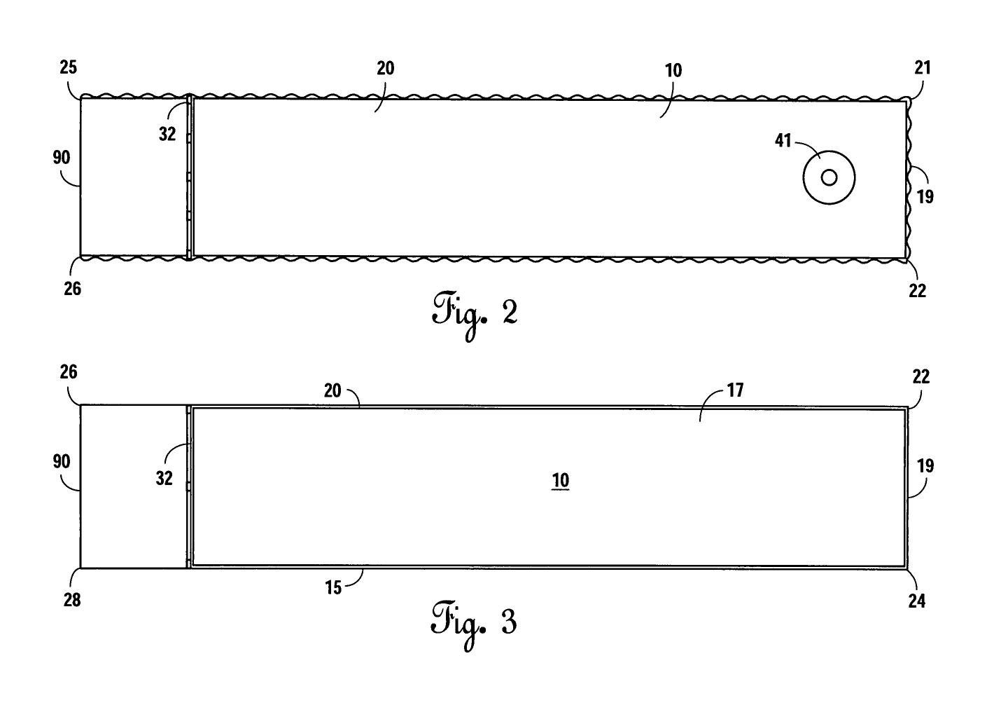

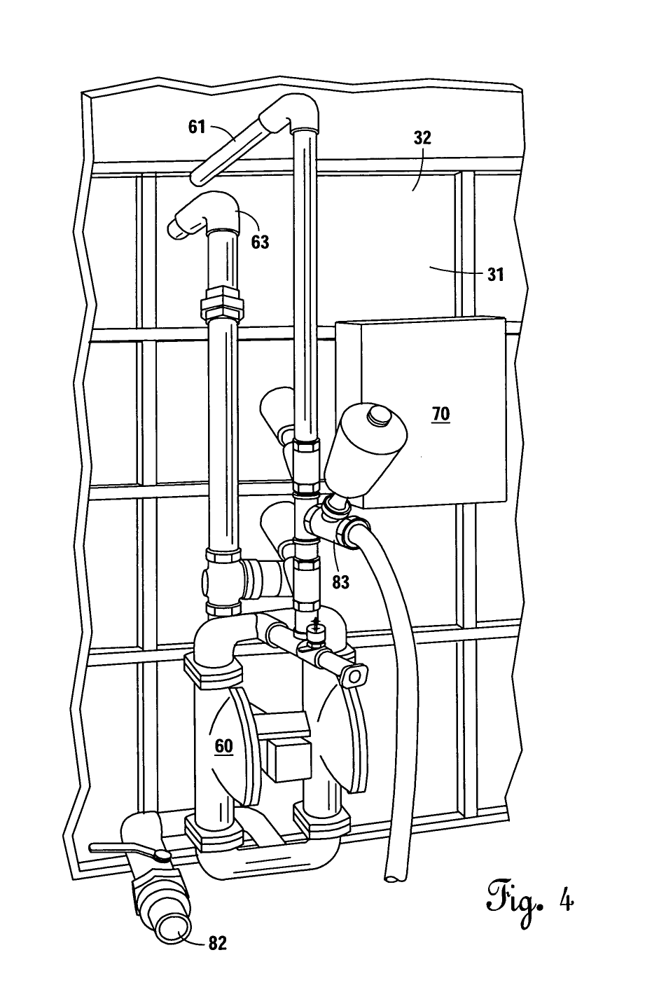

FIGS. 1-4 illustrate a storage and transport tank 10. The storage and transport tank 10 of the present invention is box-shaped and in the preferred embodiment is constructed from a standard ISO or U.S. domestic shipping container. The storage and transport tank 10 includes a floor 15, a roof 20, side walls 16 and 17, an end wall 19, a door 90, a hatchway 41, corner braces 21-28, and a chassis support 29. The storage and transport tank 10 may be constructed of any suitable material but in the preferred embodiment of the invention the side walls 16 and 17, end wall 19, roof 20, door 90, hatchway 41, corner braces 21-28, and chassis support 29 are made of steel and floor 15 is made of wood although there are instances where the floor 15 will be constructed from steel as well. The storage and transport tank 10 will have an exterior 300 and an interior 301.

The exterior 300 of the storage and transport tank 10 will resemble a standard ISO or U.S. domestic shipping container as this will facilitate the transportation of the empty storage and transport tank 10 on an industry-standard truck, railcar, or container ship to the job site. The chassis support 29 is boxed shaped and provides the structural support for the storage and transport tank 10. The corner braces 21-28 are attached at the corners of the storage and transport tank 10 by any suitable means such as welding. The corner braces 21-28 provide support, and allow the storage and transport tank 10 to be stacked either on the top or the bottom of another shipping container thereby allowing the tankage footprint to be reduced at a job site.

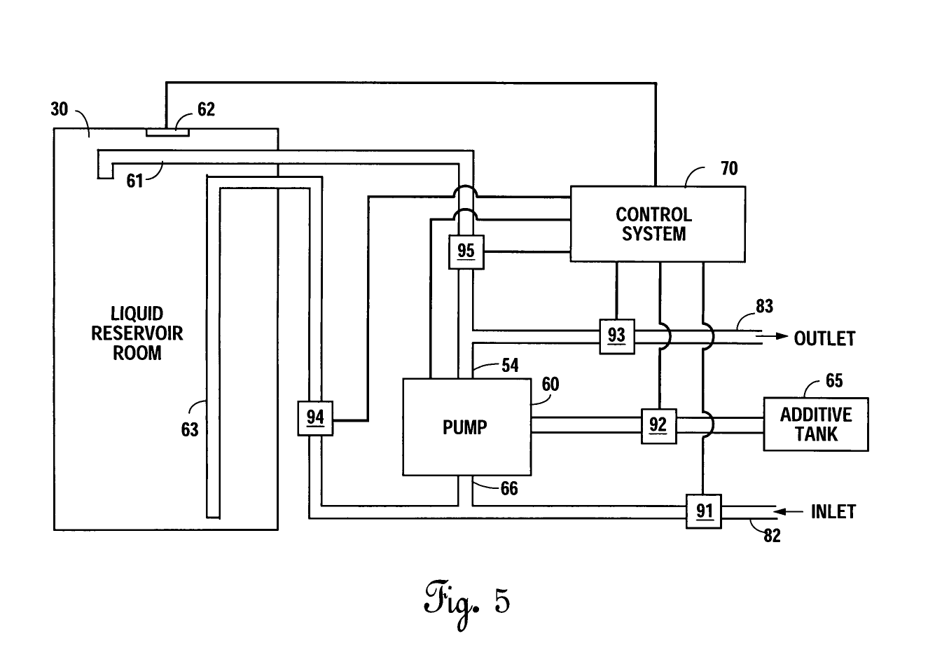

FIGS. 1 and 4 illustrate the interior 301 of the storage and transport tank 10. The interior 301 of the storage and transport tank 10 includes a liquid reservoir room 30 and a control room 31. The liquid reservoir room 30 and the control room 31 are formed by placing a bulkhead 32 inside the container at a predetermined distance from the door 90 so that the interior of the storage and transport tank 10 is divided into at least a first room and a second room. In the preferred embodiment of the invention, the bulkhead 32 is made of steel and is secured within the interior 301 of the storage and transport tank 10 by welding. After installing the bulkhead 32, the liquid reservoir room 30 will have a front end 500 and a back end 501. It should be noted if more than one reservoir room is required, multiple bulkheads may be placed within the reservoir room 30 to further divide the reservoir room 30 into any number of independent liquid reservoir rooms.

The liquid reservoir room 30 is equipped with a fill line 61, a fluid level indicator 62, a suction line 63, tubular supports 40, insulating foam 51, and plastic film 52. The tubular supports 40 are attached vertically to the chassis support 19 and to the interior of the end wall 19 and side walls 16 and 17 by any suitable means such as welding. The tubular supports 40 reinforce the liquid reservoir room 30 and allow the storage and transport tank 10 to withstand the added weight of liquids. The number of tubular supports 40 that are added to the storage and transport tank 10 is dependent upon the load the storage and transport tank 10 is expected to bear.

To prepare the storage and transport tank 10 for carrying liquids, insulating foam 51 and plastic film 52 are applied to the interior surfaces of the liquid reservoir room 30. The layer of insulating foam 51 and plastic film 52 provide insulation to the liquid reservoir room 30 and allow the storage and transport tank 10 to carry liquids without leaking. The insulating foam 51 is the first layer to be added to the liquid reservoir room 30. An operator gains access to the liquid reservoir room 30 through the hatchway 41 and the insulating foam 51 is applied onto the interior surfaces of the liquid reservoir room 30 using any suitable means, such as a compressed air driven sprayer. The insulating foam 51 is sprayed onto the interior surfaces of the floor 15, the side walls 16 and 17, the roof 20, the end wall 19, and the bulkhead 32.

The plastic film 52 is the next layer to be added to the liquid reservoir room 30. The plastic film 52 is sprayed onto the insulating foam 51 after the insulating foam 51 has cured. As with the insulating foam 51, an operator gains access to the liquid reservoir room 30 through the hatchway 41 and the plastic film 52 is applied over the insulating foam 51 using any suitable means, such as a compressed air driven sprayer.

In the preferred embodiment of invention, one layer of insulating foam 51 and plastic film 52 are sprayed into the liquid reservoir room 30, however, those of ordinary skill in the art will recognize that more layers may be added based upon the desired application for the storage and transport tank 10. Moreover, the layers of insulating foam 51 and plastic film 52 in the preferred embodiment of the invention are sprayed into the liquid reservoir room 30 such that there is a downward slope from the back end 501 to the front end 500 of the liquid reservoir room 30. The downward slope allows gravity to force liquids that are contained in the liquid reservoir room 30 towards the front end 500 thereby allowing liquids to be captured by the suction line 63.

The fill line 61 is routed from the control room 31 and into the liquid reservoir room 30. The fill line 61 is routed from the control room 31 at the highest point on the bulkhead 32 but still below the roof 20 and extends substantially and completely to the back end 501 of the liquid reservoir room 30. The fill line 61 is attached to the bulkhead 32 by any suitable means such as welding. In the preferred embodiment of the invention, the bulkhead 32 structurally supports the fill line 61; nevertheless, those of ordinary skill in the art will recognize that brackets could be added to the roof 20 to aid in securing the fill line 61. A fluid level indicator 62 may be attached to the fill line 61. The fluid level indicator 62 uses sonar to “ping” the location of any liquid stored in the liquid reservoir room 30 thereby allowing an operator to determine the fluid level within the liquid reservoir room 30.

The suction line 63 is routed from the control room 31 and into the liquid reservoir room 30. As with the fill line 61, the suction line is also routed from the control room 31 at the highest point on the bulkhead 32 but still below the roof 20. The suction line 63 is attached to the bulkhead 32 by any suitable means such as welding. In the preferred embodiment of the invention, the bulkhead 32 structurally support the suction line 63; nevertheless, those of ordinary skill in the art will recognize that brackets could be added to the roof 20 to aid in securing the suction line 63. To facilitate the capture of liquids, the suction line 63 is placed near the bulkhead 32 and extends substantially and completely to the floor 20 of the storage and transport tank 10.

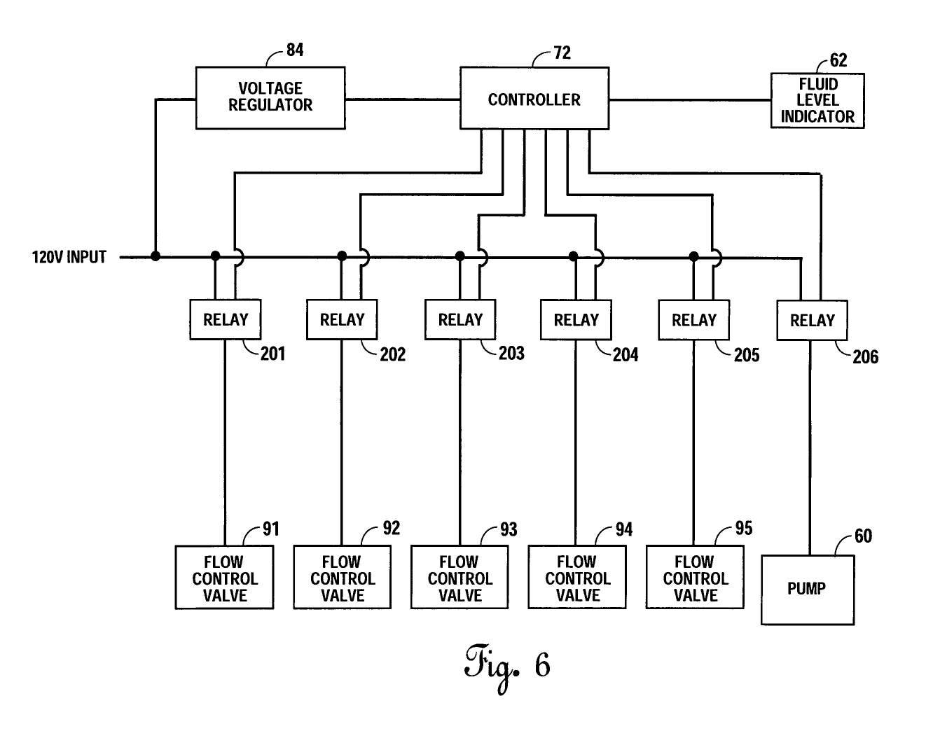

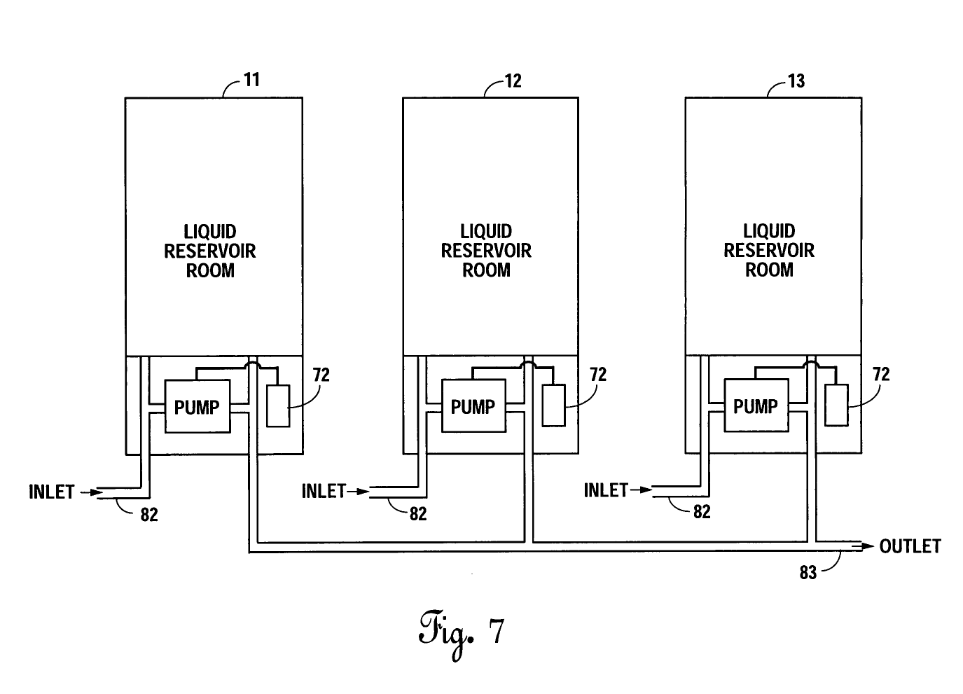

FIGS. 4-6 illustrate the control room 31 of the storage and transport tank 10. The control room 31 contains a door 90, a fill line 61, a suction line 63, a pump 60, a control system 70, an inlet line 82, an outlet line 83, flow control valves 91-95, and an additive tank 65. The door 90 allows an operator access to the control room 31. It should be noted that in the preferred embodiment of the invention there is one door that allows access to the control room 31; however, more doors may be added if desired. In addition, the door 90 may be removed from the storage and transport tank 10 and a roll up door substituted. Although in the preferred embodiment of the invention, there is one control room 31, it should be noted that one or more walls may be installed to further sub-divide the control room 31 for the purpose of segregating process equipment, such as pumps, boilers, heat-exchangers, centrifuges, filters, and the like, from electronic controls or other data acquisition equipment typically placed in a control room.

As previously described, the fill line 61 is located at the top of the bulkhead 32 and extends into the liquid reservoir room 30. The fill line 61 further runs from the top of the bulkhead 32 to an outlet port 54 of the pump 60 in the control room 31 such that liquids may be pumped into the liquid reservoir room 30 via the fill line 61. The fill line 61 includes the flow control valve 95 which is normally closed and opens under the control of the control system 70 to allow liquid to pass from the pump 60 into the liquid reservoir room 30 through the fill line 61.

The suction line 63 is located at the top of the bulkhead 32 and extends into the liquid reservoir room 30. The suction line 63 further runs from the top of the bulkhead 32 to an inlet port 66 of the pump 60 in the control room 31 such that liquids may be pumped out of the liquid reservoir room 30 via the suction line 63. The suction line 63 includes the flow control valve 94 which is normally closed and opens under the control of the control system 70 to allow liquid to pass from the liquid reservoir room 30 and into the pump 60 through the suction line 63.

The inlet line 82 is located in the control room 31 and allows the storage and transport tank 10 to be filled with liquid from an external liquid source. An external liquid source is attached to the inlet line 82 by any suitable means such as a hose. The inlet line 82 includes the flow control valve 91 which is normally closed and opens under the control of the control system 70 to allow liquid to pass from the external liquid source and into the inlet port 66 of the pump 60 through the inlet line 82.

The outlet line 83 is located in the control room 31 and allows the storage and transport tank 10 to be drained of liquid. The outlet line 83 includes the flow control valve 93 which is normally closed and opens under the control of the control system 70 to allow liquid to pass from the outlet port 54 of the pump 60 into the outlet line 83 and to an end use application. The liquid pumped from the liquid reservoir room 30 via outlet line 83 typically is delivered to the end use application through any suitable means such as a hose connected with the outlet line 83.

The additive tank 65 is located in the control room 31 and allows either additive to be delivered into the storage and transport tank 10 along with a liquid or additive to be injected into a liquid as the liquid is pumped from the liquid reservoir room 30. The additive tank 65 includes the flow control valve 92 which is normally closed and opens under the control of the control system 70 to allow liquid to pass from the additive tank 65 and into the pump 60.

The control system 70 controls the pump 60 and the flow control valves 91-95 to perform one of several actions: filling the liquid reservoir room 30, emptying the liquid reservoir room 30, and recirculating the liquid with the liquid reservoir room 30. The control system 70 further controls the delivery of an additive into the liquid from the additive tank 65. In the preferred embodiment, the pump 60 is any pumping device known to those of ordinary skill in the art suitable to pump liquids such as a positive displacement pump.

The control system 70 includes a controller 72 and relays 201-206. The controller 72 operates the relays 201-206 to activate the pump 60 and open and close a respective flow control valve 91-95 such that liquid and/or an additive may be delivered to, removed from, or recirculated within the liquid reservoir room 30. The controller 72 may be any suitable control device including but not limited to a programmable logic controller (PLC), a microprocessor, a computer, and the like. In the preferred embodiment, the controller is a PLC. The control system 70 in the preferred embodiment includes an input line adapted for connection with any suitable 120V output such as a standard outlet or generator. Moreover, the control system 70 includes a voltage regulator 84 to provide the DC voltage levels required by such devices. While the controller 72 in the preferred embodiment has been described as a solid-state device, one of ordinary skill in the art will recognize that non-solid state switches may be employed.

The controller 72 includes a user interface that allows an operator to receive command prompts and input commands. The user interface includes but is not limited to an LCD display and an input keypad. Once the controller 72 is powered, it provides an operator with selections including at least “fill”, “empty”, “recirculate”, and “additive”. Upon the selection of “fill”, the controller activates relays 206, 205, and 201, resulting in the activation of the pump 60 and the opening of the flow control valves 95 and 91. With the pump 60 on and the flow control valves open, liquid from a liquid source flows through the inlet line 65 and into the pump 60. The liquid exits the pump 60 and enters the fill line 61 for discharge into the liquid reservoir room 30. During the delivery of liquid into the liquid reservoir room 30, the fluid level indicator 62 measures the level of liquid in the liquid reservoir room 30 and outputs a signal representing that level to the controller 72. When that signal indicates the liquid reservoir room is full, the controller 72 deactivates the relays 206, 205, and 201, thereby deactivating the pump 60 and closing the flow control valves 91 and 95. In addition, the controller 72 displays the liquid level to the operator, and provides the operator with an input selection to stop the delivery of liquid into the liquid reservoir room 30.

Upon the selection of “empty”, the controller 72 activates relays 206, 203, and 204, resulting in the activation of the pump 60 and the opening of the flow control valves 93 and 94. With the pump 60 on and the flow control valves open, liquid from the liquid reservoir room 30 flows through the suction line 63 and into the pump 60. The liquid exits the pump 60 and enters the outlet line 83 for discharge to an end use application or appropriate external receptacle. During the delivery of liquid into an external receptacle, the fluid level indicator 62 measures the level of liquid in the liquid reservoir room 30 and outputs a signal representing that level to the controller 72. When that signal indicates the liquid reservoir room is empty, the controller 72 deactivates the relays 206, 203, and 204, thereby deactivating the pump 60 and closing the flow control valves 93 and 94. In addition, the controller 72 displays the liquid level to the operator, and provides the operator with an input selection to stop the delivery of liquid from the liquid reservoir room 30.

Upon the selection of “recirculate”, the controller 72 activates relays 206, 204, and 205, resulting in the activation of the pump 60 and the opening of the flow control valves 94 and 95. With the pump 60 on and the flow control valves open, liquid from the liquid reservoir room 30 flows through the suction line 63 and into the pump 60. The liquid exits the pump 60 and enters the fill line 61 for discharge into the liquid reservoir room 30. The controller 72 provides the operator with an input selection to stop the recirculation of the liquid in the liquid reservoir room 30. After selecting the stop input selection, the controller 72 deactivates the relays 206, 204, and 205 thereby deactivating the pump 60 and closing the flow control valves 94 and 95.

In the alternative, the controller 72 may include a timer that provides the operator with the ability to enter a recirculation time. After selection of “recirculate” by the operator, the controller 72 prompts the operator to input a recirculation time, which is then used by the timer in the recirculation of the liquid. Once the recirculation time is inputted, the controller 72 activates the relays 206, 204, and 205 to begin the recirculation process, which continues until the expiration of the input recirculation time. Upon the expiration of the input recirculation time, the controller 72 deactivates the relays 206, 204 and 205 thereby deactivating the pump 60 and closing the flow control valves 94 and 95.

In a further alternative, the controller 72 may include a timing routine that automatically recirculates the liquid at predetermined intervals for a predetermined time. After selection of “recirculate” by the operator, the controller 72 prompts the operator to input a recirculation interval and a recirculation time, which is then used by the timing routine in the recirculation of the liquid. Once the recirculation interval and time are inputted, the controller 72 begins a timer set to the recirculation interval. At the expiration of the recirculation interval, the controller 72 activates the relays 206, 204, and 205 to begin the recirculation process, which continues until the expiration of the recirculation time. Upon the expiration of the input recirculation time, the controller 72 deactivates the relays 206, 204 and 205 thereby deactivating the pump 60 and closing the flow control valves 94 and 95. The controller 72 then resets the recirculation interval timer to determine the next recirculation.

After the selection of either “fill” or “empty”, the controller 72 prompts the operator regarding the introduction of an additive. If the operator selects “additive”, the controller 72 activates the relay 202, resulting in the opening of the flow control valve 92. With the pump 60 on due to the “fill” or “empty” selection, additive from the additive tank 65 flows into the pump 60 for combination with the liquid flowing through the pump 60. The controller 72 may maintain the relay 202 activated and the flow control valve 92 open until the deactivation of the pump 60. Alternatively, the controller 72 may include a timing routine that introduces additive for a predetermined time period. Furthermore, the additive tank 65 may include an additive level sensor coupled with the controller 72 such that, upon an indication that the additive tank 65 is empty, the controller 72 deactivates the relay 202 and relays 206, 204, and 205 if desired.

The storage and transport tanks 10 of the preferred embodiment present improvements in the transportation, storage, and delivery of liquids because the storage and transport tanks 10 are stackable and sized for transport using existing means such as flatbed trucks and trains. As such, the storage and transport tanks 10 are easily deliverable to necessary use areas either pre-filled or filled on-site. Furthermore, the storage and transport tanks 10 because of the inclusion of a control room 31 are configurable on-site to deliver different product ingredients to an end use application. A non-limiting example product ingredient delivery for an end use application includes fracturing of a subterranean hydrocarbon bearing formation.

It is well known that fracturing treatments in a single oil or gas well may require millions of gallons of water pumped over a period of days or weeks. Fracturing treatments require a suite of chemical additives to render the water suitable for use as a hydraulic fluid capable of initiating and propagating a fracture, transporting proppant into the induced subterranean fracture, and then “breaking” the fracturing fluid to a low viscosity suitable to be recovered from the propped fracture and hydrocarbon bearing formation without pulling the proppant out of the fracture and back into the wellbore. Typical chemical additives include salts and buffers, polymers and crosslinkers, biocides, breakers, non-emulsifiers, foamers and friction reducers. Fracturing additives must be added at a quantity and at a rate corresponding to the pre-determined recipe for the fracturing fluid. For instance, a friction reducer (FR) concentration 0.5 gallons of FR per 1000 gallons of fracturing fluid to achieve a predetermined reduction in the surface treating pressure of the fracturing treatment. If the total liquid pump rate is 60 barrels per minute, the FR must be added at a rate of 1.26 gallons per minute, but if the rate is increased to 75 barrels per minute, the FR feed rate must be correspondingly increased to 1.58 gallons per minute. If the well has 20 zones to be fractured requiring 1,000,000 gallons per zone, total FR additive requirements would be 10,000 gallons. The inventive converted container can be configured to serve as a single unit to contain the entire chemical additive requirement as well as the appropriate pumps, valves, and meters in the control room to serve the intended chemical additive function.

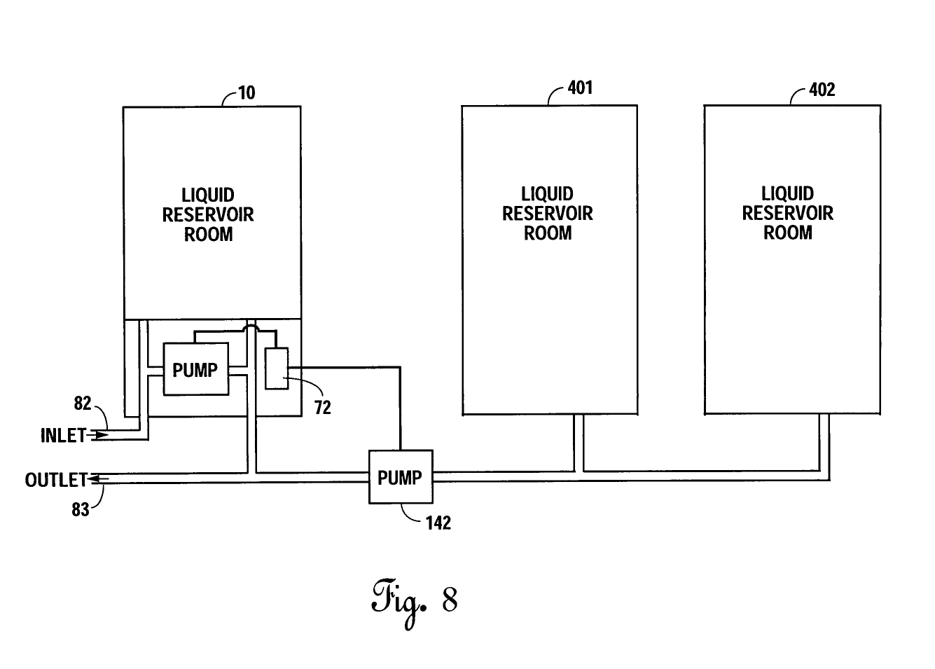

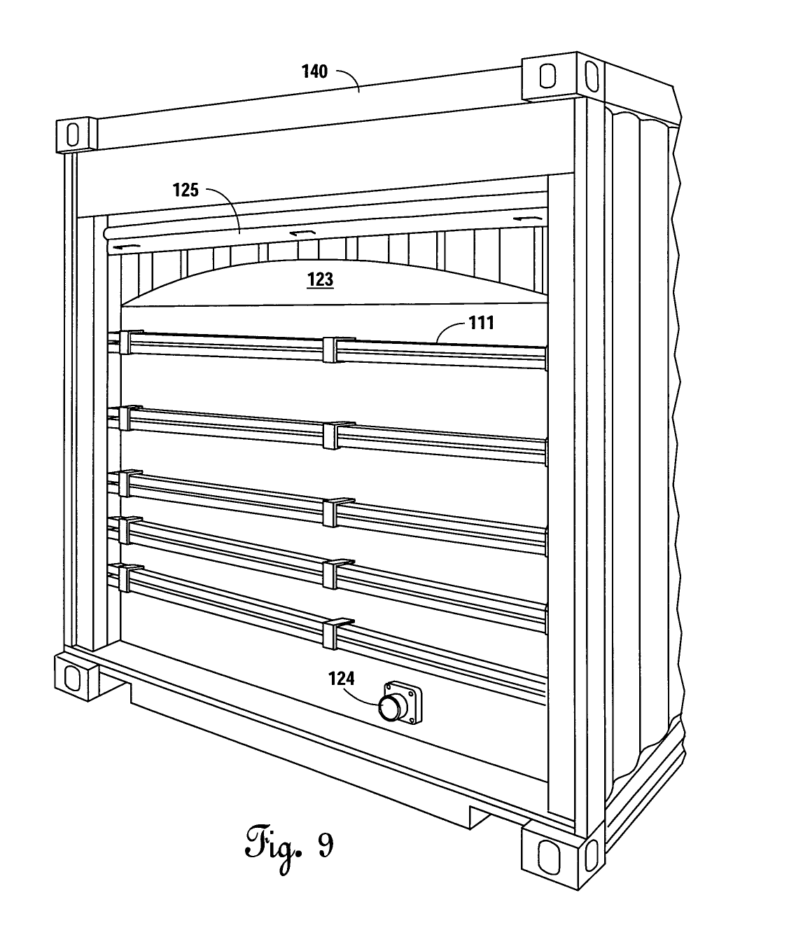

FIG. 7 provides an example configuration where three different product ingredients are contained in three storage and transport tanks for combination into a final product delivered to an end use application such as a fracturing treatment. While FIG. 8 illustrates three product ingredients, it should be understood by those of ordinary skill in the art that the type and number of product ingredients is determined by the end use application. In operation, first, second, and third storage and transport tanks 11, 12, and 13 are filled through their inlet lines 82 as previously described either on-site or pre-delivery with first, second, and third product ingredients, respectively. To deliver the first, second, and third product ingredients to the end use application, the outlet lines 83 of the storage and transport tanks 11, 12, and 13 are each connected to a central hose system that ultimately connects with the end use application. Once the storage and transport tanks 11, 12, and 13 are connected, an operator uses each control system 70 of the storage and transport tanks 11, 12, and 13 as previously described to deliver the first, second, and third products into the central hose system. The storage and transport tanks 11, 12, and 13 deliver their respective products until delivery is stopped by either the operator or by the controllers 72 of the control systems 70 as previously described.

FIG. 8 provides an example configuration where three different product ingredients are contained in a storage and transport tank 10 and alternative storage and transport tanks 401 and 402 for combination into a final product delivered to an end use application such as a fracturing treatment. While FIG. 8 illustrates three product ingredients, it should be understood by those of ordinary skill in the art that the type and number of product ingredients is determined by the end use application.

FIG. 9 illustrates the alternative storage and transport tank 401. Storage and transport tank 402 is substantially identical to storage and transport tank 401; accordingly, only storage and transport tank 401 will be described herein. The storage and transport tank 401 is constructed from a standard ISO or U.S. domestic shipping container 140 including a door 125 and outfitted with a containment wall 111 and a bladder tank 123 having an outlet nozzle 124. The bladder tank 123 resides within the shipping container 140 behind the containment wall 111. The containment wall 111 includes an opening that receives the outlet nozzle 124 of the bladder tank 123 therethrough. While the bladder tank 123 is available from many sources, the bladder tank 123 in the preferred embodiment is a bladder tank from Environmental Packaging Technologies, whose address is 6100 West by Northwest, Suite 100, Houston, Tex. 77040.

Returning to FIG. 8, a storage and transport tank 10 is filled through its inlet line 82 as previously described either on-site or pre-delivery with a first product ingredient. Likewise, the storage and transport tanks 401 and 402 are filled either on-site or pre-delivery with second and third product ingredients, respectively. A pump is connected between a second product source and the outlet nozzle 124 of the storage and transport tank 401 via any suitable means such as hoses. The pump is activated to deliver the second product ingredient until deactivated responsive to the filling of the bladder tank 123 to a desired level. Similarly, a pump is connected between a third product source and the outlet nozzle 124 of the storage and transport tank 402 via any suitable means such as hoses. The pump is activated to deliver the third product ingredient until deactivated responsive to the filling of the bladder tank 123 to a desired level.

To deliver the first, second, and third product ingredients to the end use application, the outlet nozzles 124 of the storage and transport tanks 401 and 402 are each connected to a pump 142 via any suitable means such as hoses. While the pump 142 is shown external to the storage and transport tank 10, those of ordinary skill in the art will recognize that the pump 142 may be included in the control room 31 of the storage and transport tank 10. Moreover, the controller 72 for the control system 70 of the storage and transport tank 10 is connectable with pump 142 such that the controller 72 controls the operation of the pump 142. In particular, the control system 70 includes a relay connected to the input line of the control system and to the controller 72. Furthermore, the relay includes an output line that is connectable with the pump 142. It should be understood by those of ordinary skill in the art that the controller 72 includes a secondary pump routine that operates similarly to the pump routine necessary for pump 60.

After connecting the outlet nozzles 124 to the pump 142, the pump 142 connects to a central hose system that ultimately connects with the end use application. Likewise, the outlet line 83 of the storage and transport tank 10 connects to the central hose system. Once the storage and transport tanks 10, 401, and 402 are connected, an operator uses the control system 70 of the storage and transport tank 10 to deliver the first, second, and third products into the central hose system. The controller 72 activates the pump 60 of the storage and transport tank 10 as previously described. In addition, the controller 72 activates the relay connected with the pump 142 thereby activating the pump 142. The storage and transport tanks 10, 401, and 402 deliver their respective products until delivery is stopped by either the operator or by the controller 72 of the control system 70 as previously described.

Although the present invention has been described in terms of the foregoing embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

1. A storage and transport tank, comprising:
a shipping container;
a bulkhead disposed within the shipping container such that the bulkhead divides the shipping container into a first room and a second room;
a liquid reservoir room formed from the first room through the application of insulating foam onto the interior surfaces of the first room and the coating of the insulating foam with a plastic film;
a fill line extending from the second room into the liquid reservoir room, the fill line including a flow control valve;
a suction line extending from the second room into the liquid reservoir room, the suction line including a flow control valve; and
a control room formed in the second room, the control room, comprising:
a pump including an inlet port coupled with the suction line and an inlet line including a flow control valve and an outlet port coupled with the fill line and an outlet line including a flow control valve, and
a control system coupled with the pump and the flow control valves of the fill line, the suction line, the inlet line, and the outlet line, wherein the control system activates the pump and opens the flow control valves of the inlet line and the fill line to deliver liquid into the liquid reservoir room and activates the pump and opens the flow control valves of the outlet line and the suction line to remove liquid from the liquid reservoir room.

2. The storage and transport tank according to claim 1, wherein the control system activates the pump and opens the flow control valves of the suction line and the fill line to recirculate liquid within the liquid reservoir room.

3. The storage and transport tank according to claim 2, wherein the control system recirculates the liquid within the liquid reservoir room for a predetermined time period.

4. The storage and transport tank according to claim 1, wherein the liquid reservoir room is formed from the first room through the attachment of supports to interior walls of the first room.

5. The storage and transport tank according to claim 1, wherein the insulating foam is applied onto the interior surfaces of the first room such that the liquid reservoir room slopes downward to one end.

6. The storage and transport tank according to claim 5, wherein the fill line extends into the liquid reservoir room at a beginning of the downward slope.

7. The storage and transport tank according to claim 5, wherein the suction line extends towards a bottom of the liquid reservoir room at an end of the downward slope.

8. The storage and transport tank according to claim 1, further comprising additive tank coupled with the pump for delivering additive into a pumped liquid during activation of the pump.

9. The storage and transport tank according to claim 1, further comprising a hatchway that allows access into the liquid reservoir room.

10. The storage and transport tank according to claim 1, further comprising a door that seals the control room and provides access thereto.

11. The storage and transport tank according to claim 1, wherein the control system, comprises:
an input line for inputting power to the control system;
a pump relay coupled with the input line and the pump;
a line relay coupled with the input line and each of the flow control valves of the fill line, suction line, inlet line, and outlet line; and
a controller coupled with the input line, the pump relay, and each of the line relays, wherein the controller:
activates the pump relay to deliver power to the pump and activates the line relays coupled with the flow control valves for the inlet line and the fill line thereby opening the flow control valves and delivering liquid into the liquid reservoir room, and
activates the pump relay to deliver power to the pump and activates the line relays coupled with the flow control valves for the outlet line and the suction line thereby opening the flow control valves and removing liquid from the liquid reservoir room.

12. The storage and transport tank according to claim 11, wherein the controller activates the pump relay to deliver power to the pump and activates the line relays coupled with the flow control valves for the suction line and the fill line thereby opening the flow control valves and recirculating the liquid within the liquid reservoir room.

13. The storage and transport tank according to claim 1, further comprising a fluid level indicator disposed in the liquid reservoir room, wherein the fluid level indicator measures the level of liquid within the liquid reservoir room and outputs a signal to the control system representative thereof.

14. The storage and transport tank according to claim 12, wherein the control system deactivates the pump and closes the flow control valves of the inlet line and the fill line when the signal indicates the liquid reservoir room is filled.

15. A method of converting a shipping container into a storage and transport tank, comprising:
securing a bulkhead within a shipping container such that the bulkhead divides the shipping container into a first room and a second room;
coating the interior surfaces of the first room with an insulating foam;
coating the insulating foam with a plastic film to form a liquid reservoir room;
extending a fill line including a flow control valve from the second room into the liquid reservoir room;
extending a suction line including a flow control valve from the second room into the liquid reservoir room;
placing a pump in the second room;
coupling an inlet port of the pump with the suction line and an inlet line including a flow control valve;
coupling an outlet port with the fill line and an outlet line and including a flow control valve; and
coupling a control system with the pump and the flow control valves of the fill line, the suction line, the inlet line, and the outlet line.

16. The method of converting a shipping container into a storage and transport tank according to claim 15, wherein the control system activates the pump and opens the flow control valves of the inlet line and the fill line to deliver liquid into the liquid reservoir room and activates the pump and opens the flow control valves of the outlet line and the suction line to remove liquid from the liquid reservoir room.

17. The storage and transport tank according to claim 16, wherein the control system further activates the pump and opens the flow control valves of the suction line and the fill line to recirculate liquid within the liquid reservoir room for a predetermined period of time.

18. The method of converting a shipping container into a storage and transport tank according to claim 15, wherein coating the interior surfaces of the first room with an insulating foam comprises applying the insulating foam such that the liquid reservoir room slopes downward to one end.

19. The method of converting a shipping container into a storage and transport tank according to claim 15, further comprising coupling an additive tank with the pump for delivering additive into a pumped liquid during activation of the pump.

20. The method of converting a shipping container into a storage and transport tank according to claim 15, further comprising placing a hatchway in the shipping container that allows access into the liquid reservoir room.

21. The method of converting a shipping container into a storage and transport tank according to claim 15, further comprising placing a door on the shipping container that seals the second room and provides access thereto.

22. A method of storing and transporting liquids, comprising:
delivering a storage and transport tank to an end use application, the storage and transport tank comprising a shipping container converted to include a liquid reservoir room and a control room comprising a pump adapted to deliver liquids to and remove liquids from the liquid reservoir room and a control system that controls the operation of the pump;
connecting the pump to a liquid source;
activating the pump utilizing the control system, thereby delivering liquid into the liquid reservoir room;
deactivating the pump utilizing the control system when the liquid reservoir room is filled;
connecting the pump to the end use application;
activating the pump utilizing the control system, thereby delivering liquid from the liquid reservoir room to the end use application; and
deactivating the pump utilizing the control system upon completion of the end use application.

23. The method of storing and transporting liquids according to claim 22, wherein deactivating the pump utilizing the control system when the liquid reservoir room is filled, comprises:
monitoring the level of liquid within the liquid reservoir room;
outputting a signal representative of the level of liquid within the liquid reservoir room to the control room; and
deactivating the pump utilizing the control system when the signal indicates the liquid reservoir room is filled.

24. The method of storing and transporting liquids according to claim 22, further comprising:
providing an additive tank coupled with the pump; and
delivering additive into the liquid during activation of the pump.

25. A method of storing and transporting liquids, comprising:
providing a storage and transport tank comprising a shipping container converted to include a liquid reservoir room and a control room comprising a pump adapted to deliver liquids to and remove liquids from the liquid reservoir room and a control system that controls the operation of the pump;
connecting the pump to a liquid source;
activating the pump utilizing the control system, thereby delivering liquid into the liquid reservoir room;
deactivating the pump utilizing the control system when the liquid reservoir room is filled;
delivering the storage and transport tank to an end use application;
connecting the pump to the end use application;
activating the pump utilizing the control system, thereby delivering liquid from the liquid reservoir room to the end use application; and
deactivating the pump utilizing the control system upon completion of the end use application.

26. The method of storing and transporting liquids according to claim 25, wherein deactivating the pump utilizing the control system when the liquid reservoir room is filled, comprises:
monitoring the level of liquid within the liquid reservoir room;
outputting a signal representative of the level of liquid within the liquid reservoir room to the control room; and
deactivating the pump utilizing the control system when the signal indicates the liquid reservoir room is filled.

27. The method of storing and transporting liquids according to claim 25, further comprising:
providing an additive tank coupled with the pump; and
delivering additive into the liquid during activation of the pump.

28. A method of combining first and second product ingredients at an end use application to deliver a final product to the end use application, comprising:
providing a first storage and transport tank at the end use application, the first storage and transport tank comprising a shipping container converted to include a liquid reservoir room filled with a first product ingredient and a control room comprising a pump adapted to deliver liquids to and remove liquids from the liquid reservoir room and a control system that controls the operation of the pump;
providing a second storage and transport tank at the end use application, the second storage and transport tank comprising a shipping container converted to include a liquid reservoir room filled with a second product ingredient and a control room comprising a pump adapted to deliver liquids to and remove liquids from the liquid reservoir room and a control system that controls the operation of the pump;
connecting a hose system with the end use application;
connecting the pump of the first storage and transport tank with the hose system;
connecting the pump of the second storage and transport tank with the hose system;
activating the pump of the first storage and transport tank utilizing the control system of the first storage and transport tank, thereby delivering the first product ingredient from the liquid reservoir room of the first storage and transport tank to the end use application;
activating the pump of the second storage and transport tank utilizing the control system of the second storage and transport tank, thereby delivering the second product ingredient from the liquid reservoir room of the second storage and transport tank to the end use application;
deactivating the pump of the first storage and transport tank utilizing the control system of the first storage and transport tank upon completion of the end use application; and
deactivating the pump of the second storage and transport tank utilizing the control system of the second storage and transport tank upon completion of the end use application.

29. A method of combining first and second product ingredients at an end use application to deliver a final product to the end use application, comprising:
providing a first storage and transport tank at the end use application, the first storage and transport tank comprising a shipping container converted to include a liquid reservoir room filled with a first product ingredient and a control room comprising a pump adapted to deliver liquids to and remove liquids from the liquid reservoir room and a control system that controls the operation of the pump;
providing a second storage and transport tank at an end use application, the second storage and transport tank comprising a shipping container converted to include a bladder tank filled with a second product ingredient;
connecting a pump to an outlet nozzle for the bladder tank of the second storage and transport tank;
coupling the control system of the first storage and transport tank with the pump connected with the outlet nozzle for the bladder tank of the second storage and transport tank;
connecting a hose system with the end use application;
connecting the pump of the first storage and transport tank with the hose system;
connecting the pump for the second storage and transport tank with the hose system;
activating the pump of the first storage and transport tank utilizing the control system of the first storage and transport tank, thereby delivering the first product ingredient from the liquid reservoir room of the first storage and transport tank to the end use application;
activating the pump for the second storage and transport tank utilizing the control system of the first storage and transport tank, thereby delivering the second product ingredient from the bladder tank of the second storage and transport tank to the end use application;
deactivating the pump of the first storage and transport tank utilizing the control system of the first storage and transport tank upon completion of the end use application; and
deactivating the pump for the second storage and transport tank utilizing the control system of the first storage and transport tank upon completion of the end use application.
